(19) United States
(12) Patent Application Publication
(10) Pub. No.: US 2015/0076945 A1
(43) Pub. Date: Mar. 19, 2015

(54) STATOR FOR ROTATING ELECTRIC MACHINE

(71) Applicant: DENSO CORPORATION, Kariya-city (JP)

(72) Inventors: Takuya KUDOU, Kariya-shi (JP); Hiroaki TAKEDA, Toyota-shi (JP)

(21) Appl. No.: 14/491,194

(22) Filed: Sep. 19, 2014

(30) Foreign Application Priority Data
Sep. 19, 2013 (JP) 2013-193775

(51) Int. Cl. H02K 3/28; H02K 3/48

(52) U.S. Cl. CPC H02K 3/28; H02K 3/48
USPC 310/71

(57) ABSTRACT

A stator includes an annular stator core and a stator coil. The stator core has a plurality of slots formed therein. The stator coil includes first to third phase windings mounted on the stator core and a connection portion located outside the slots of the stator core. The connection portion is formed of a first connection wire connecting the first and second phase windings and a second connection wire connecting the third phase winding to the first connection wire. The first connection wire is arranged so as to extend in the circumferential direction of the stator core. The second connection wire is bent to include a bend and an intersecting part that extends from the bend to the first connection wire so as to intersect the first connection wire. The intersecting part of the second connection wire is joined to the first connection wire with a joint formed therebetween.

### CROSS-REFERENCE TO RELATED APPLICATION

This application is based on and claims priority from Japanese Patent Application No. 2013-193775 filed on Sep. 19, 2013, the content of which is hereby incorporated by reference in its entirety into this application.

### BACKGROUND

1 Technical Field The present invention relates to stators for rotating electric machines that are used in, for example, motor vehicles as electric motors and electric generators.

2 Description of Related Art

Japanese Patent Application Publication No. JP2013059156A discloses a stator for a rotating electric machine The stator includes an annular stator core and a stator coil mounted on the stator core. The stator coil is comprised of first to third phase windings that are Y-connected to define a neutral point therebetween. Moreover, to facilitate the process of connecting the first to the third phase windings to form a connection portion which represents the neutral point and improve the reliability of the formed connection portion, there are employed first and second neutral wires in the stator coil. The first neutral wire, which is a single continuous electric conductor wire, extends to connect the first and second phase windings. The second neutral wire, which is also a single continuous electric conductor, extends to connect the third phase winding to the first neutral wire. More specifically, a joining portion of the second neutral wire is arranged to extend along the circumferential direction of the stator core and in contact with a joining portion of the first neutral wire. The joining portions of the first and second neutral wires are joined to each other by brazing or welding.

However, with the above arrangement of the first and second neutral wires, there is no member or part of the stator radially supporting the connection portion of the stator coil. Therefore, radial vibration transmitted from outside to the stator may cause the connection portion of the stator coil to greatly vibrate in the radial direction. Accordingly, when the rotating electric machine is used in a vehicle where the machine is subjected to high radial vibration, electrical connection failure may occur such as breakage of the connection portion of the stator coil or damage of insulating coats of the first and second neutral wires due to stress induced therein.

Further, when the above arrangement is applied to other cases where the stator coil includes more than one connection portion between the phase windings (e.g., the stator coil includes a plurality of Y-connections or a A-Y connection), the probability of electrical connection failure occurring in the stator coil will accordingly increase.

To prevent electrical connection failure from occurring in the stator coil, one may consider firmly fixing the connection portion of the stator coil using insulating resin or binding the connection portion to a coil end part of the stator coil with threads. However, in those cases, the manufacturing cost of the stator would be increased due to increase in the man-hours required for manufacturing the stator, the amount of the insulating resin used for the stator coil, or the parts count of the stator.

Moreover, in some embodiments disclosed in the above patent document, the first and second neutral wires are arranged so as to be axially aligned with each other. However, with this arrangement, the axial height of the connection portion of the stator coil will be increased, thereby reducing the axial gap between the connection portion and an internal wall of a frame which receives the stator therein. Consequently, the environmental resistance of the rotating electric machine is lowered. In addition, the resistance of the rotating electric machine to radial vibration is also lowered.

Furthermore, with the arrangements of the first and second neutral wires disclosed in the above patent document, it is difficult to stably hold the first and second neutral wires in joining the joining portions thereof. Therefore, to facilitate the process of joining the joining portions of the first and second neutral wires by, for example, welding, it is necessary to strip the joining portions of their respective insulating coats over a wide range. Accordingly, after joining the joining portions of the first and second neutral wires, it is necessary to apply an increased amount of insulating resin onto the joining portions so as to secure electrical insulation thereof. Consequently, the manufacturing cost of the stator will be accordingly increased.

### SUMMARY

According to an exemplary embodiment, there is provided a stator for a rotating electric machine. The stator includes an annular stator core and a stator coil. The stator core has a plurality of slots formed therein. The slots are spaced from one another in a circumferential direction of the stator core. The stator coil includes first to third phase windings mounted on the stator core and a connection portion located outside the slots of the stator core. The connection portion is formed of a first connection wire connecting the first and second phase windings and a second connection wire connecting the third phase winding to the first connection wire. The first connection wire is arranged so as to extend in the circumferential direction of the stator core. The second connection wire is bent to include a bend and an intersecting part that extends from the bend to the first connection wire so as to intersect the first connection wire. The intersecting part of the second connection wire is joined to the first connection wire with a joint formed therebetween.

With the above configuration, when radial vibration is transmitted to the connection portion of the stator coil, one of the first and second connection wires will function as a strut to support the other of the first and second connection wires, thereby suppressing radial vibration of the connection portion. It is preferable that the intersecting part of the second connection wire extends in a radial direction of the stator core so as to intersect the first connection wire at right angles.

Preferably, the bend of the second connection wire is formed radially outside the first connection wire, and the intersecting part of the second connection wire extends from the bend to the first connection wire.

It is preferable that each of opposite end portions of the first connection wire is led out from a radially inner part of a corresponding one of the slots of the stator core.

It is also preferable that the first connection wire is axially positioned between the stator core and the intersecting part of the second connection wire.

It is also preferable that at the joint, a cut is formed in either or both of the first and second connection wires for positioning them with respect to each other. Further, the cut may be formed in the shape of a recess only in the second connection wire so that the first connection wire is fitted in the cut. Alternatively, at the joint, each of the first and second connection wires may have a cut formed therein in the shape of a recess so that: the first connection wire is fitted in the cut formed in the second connection wire; and the second connection wire is fitted in the cut formed in the first connection wire.

It is also preferable that each of the first and second connection wires has a substantially rectangular cross section.

### BRIEF DESCRIPTION OF THE DRAWINGS

The present invention will be understood more fully from the detailed description given hereinafter and from the accompanying drawings of one exemplary embodiment, which, however, should not be taken to limit the invention to the specific embodiment but are for the purpose of explanation and understanding only.

In the accompanying drawings:

FIG. 1 is a schematic cross-sectional view of an automotive alternator which includes a stator according to the exemplary embodiment;

FIG. 2 is a schematic perspective view illustrating the configuration of electric conductor segments forming a stator coil of the stator;

FIG. 3 is a schematic perspective view illustrating a process of inserting the electric conductor segments into slots formed in a stator core of the stator;

FIG. 4 is a schematic perspective view illustrating pairs of end portions of the electric conductor segments joined at a front-side coil end part of the stator coil;

FIG. 5 is a schematic perspective view illustrating the configuration of electric conductor segments forming the stator coil according to a first modification;

FIG. 6 is a schematic circuit diagram of the stator coil which is comprised of a pair of three-phase coils;

FIG. 7 is a schematic perspective view illustrating the configuration of electric conductor segments forming lead wires of the stator coil;

FIG. 8 is a schematic axial end view illustrating the configuration of a connection portion representing a neutral point of the stator coil;

FIG. 9 is a schematic view of the connection portion of the stator coil from the radially inside;

FIG. 10 is a schematic perspective view illustrating the configuration of the connection portion of the stator coil;

FIG. 11 is a schematic axial end view illustrating the configuration of the connection portion of the stator coil according to a second modification;

FIG. 12 is a schematic axial end view illustrating the configuration of the connection portion of the stator coil according to a third modification;

FIG. 13 is a schematic perspective view illustrating a cut formed in the connection portion of the stator coil according to a fourth modification;

FIG. 14 is a schematic perspective view illustrating a cut formed in the connection portion of the stator coil according to a fifth modification;

FIG. 15 is a schematic perspective view illustrating cuts formed in the connection portion of the stator coil according to a sixth modification;

FIG. 16 is a schematic circuit diagram of the stator coil according to a seventh modification; and

FIG. 17 is a schematic axial end view illustrating the configuration of the connection portion of the stator coil according to an eighth modification.

### DESCRIPTION OF EMBODIMENT

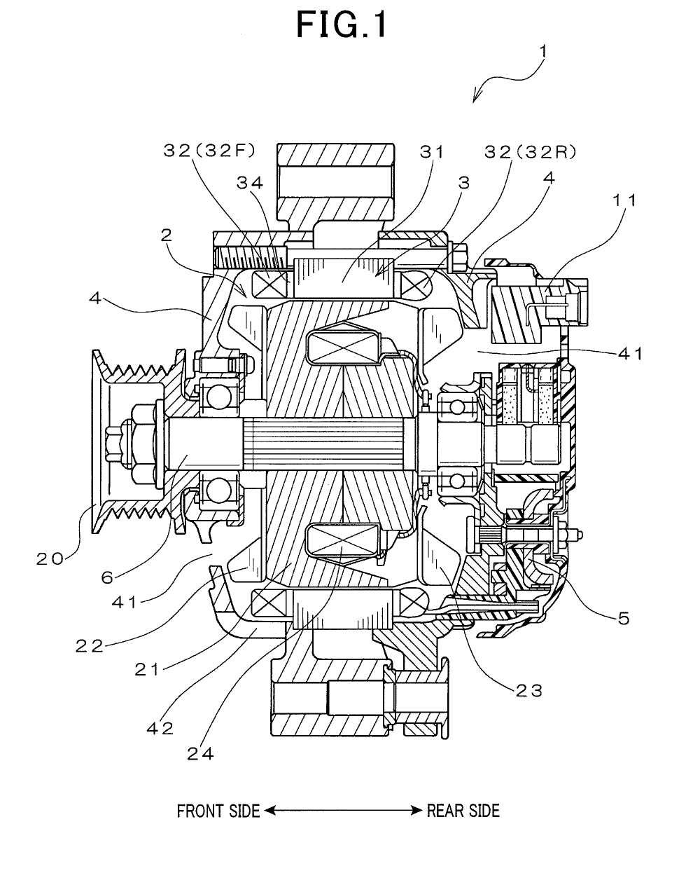

FIG. 1 shows the overall configuration of an automotive alternator 1 which includes a stator 3 according to an exemplary embodiment. The alternator 1 is designed to be used in a motor vehicle, such as a passenger car or a truck.

As shown in FIG. 1, the alternator 1 includes, in addition to the stator 3, a rotor 2, a frame 4, a rectifier 5, a voltage regulator 11 and a pulley 20.

The rotor 2 includes a rotating shaft 6, a pair of Lundell-type magnetic pole cores 21 and a field coil 24. The rotating shaft 6 is rotatably supported by the frame 4 via bearings. The rotating shaft 6 has the pulley 20 mounted on a front end portion (i.e., a left end portion in FIG. 1) thereof, so that it can be driven by an internal combustion engine (not shown in the figures) of the vehicle via the pulley 20. Each of the magnetic pole cores 21 has a plurality of magnetic pole claws. The field coil 24 is made of, for example, an insulation-treated copper wire and wound into an annular shape. The magnetic pole cores 21 are fixed on the rotating shaft 6 with the field coil 24 held between the magnetic pole cores 21. In addition, on a rear end portion (i.e., a right end portion in FIG. 1) of the rotating shaft 6, there are provided a pair of slip rings via which field current is supplied to the field coil 24 during rotation of the rotor 2.

The stator 3 includes an annular (or hollow cylindrical) stator core 31 and a stator coil 32 mounted on the stator core 31. The detailed configuration of the stator 3 will be described later.

The frame 4 has both the rotor 2 and the stator 3 retained therein so that the stator 3 surrounds a radially outer periphery of the rotor 2 with a predetermined radial gap formed therebetween.

The rectifier 5 rectifies three-phase AC power outputted from the stator coil 32 into DC power and outputs the obtained DC power via output terminals thereof.

The voltage regulator 11 regulates the voltage of the DC power outputted from the rectifier 5.

Moreover, in the present embodiment, the alternator 1 further includes a pair of cooling fans 22 and 23 that are respectively provided on axial end faces of the magnetic pole cores 21 of the rotor 2. The cooling fans 21 and 22 suck cooling air into the alternator 1 via suction openings 41 formed in front and rear end walls of the frame 4 and discharge the cooling air out of the alternator 1 via discharge openings 42 formed in a circumferential wall (or side wall) of the frame 4. With the cooling air, it is possible to cool the stator coil 32, the rectifier 5 and the regulator 11 during operation of the alternator 1. In addition, it should be noted that though not shown in FIG. 1, the discharge openings 42 are formed not only in a front part but also in a rear part of the frame 4.

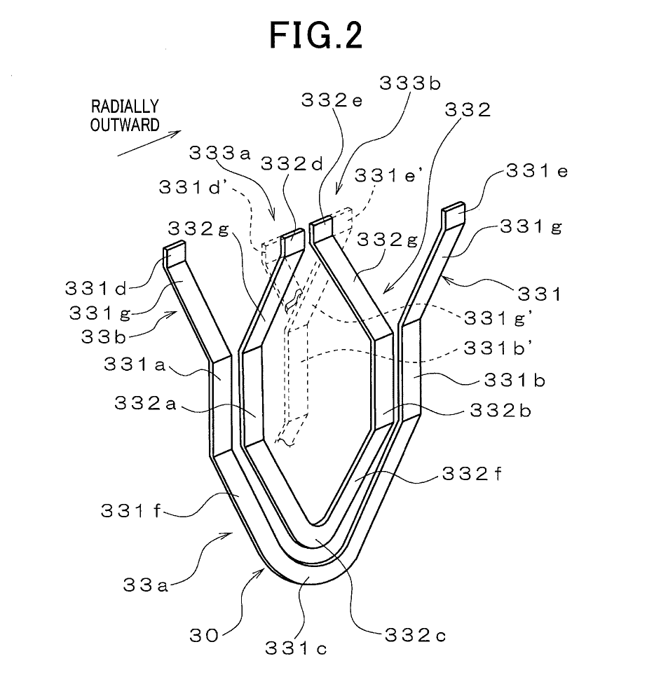

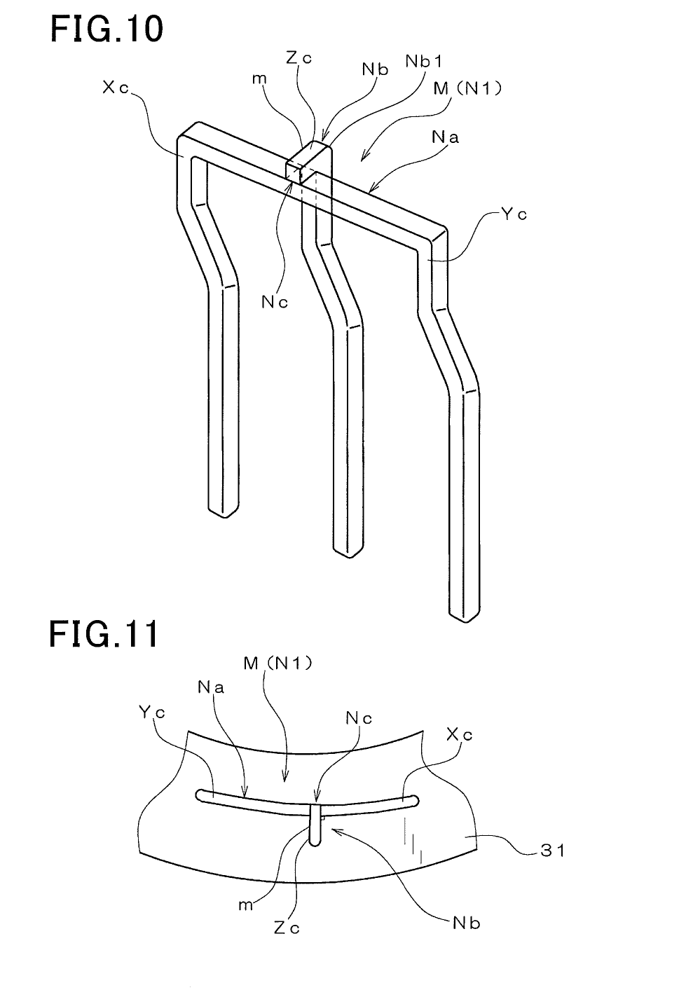

After having described the overall configuration of the alternator 1, the detailed configuration of the stator 3 according to the present embodiment will be described with reference to FIGS. 2-10.

In the present embodiment, the annular stator core 31 is formed by laminating a plurality of steel sheets in the axial direction. In the radially inner surface of the stator core 31, there are formed a plurality of slots 310 so as to penetrate the stator core 31 in the axial direction. Moreover, the slots 310 are spaced from one another in the circumferential direction of the stator core 31 at a constant pitch and each extend in a radial direction of the stator core 31. That is, for each of the slots 310, the depth direction of the slot 310 coincides with the radial direction of the stator core 31.

The stator coil 32 is mounted on the stator core 31 so as to be partially received in the slots 310 of the stator core 31 with insulating sheets 34 interposed between the stator coil 32 and those internal walls of the stator core 31 which define the slots 310. Moreover, as shown in FIG. 1, the stator coil 32 has a front-side coil end part 32F protruding from a front end face (or a first axial end face) of the stator core 31 and a rear-side coil end part 32R protruding from a rear end face (or a second axial end face) of the stator core 31.

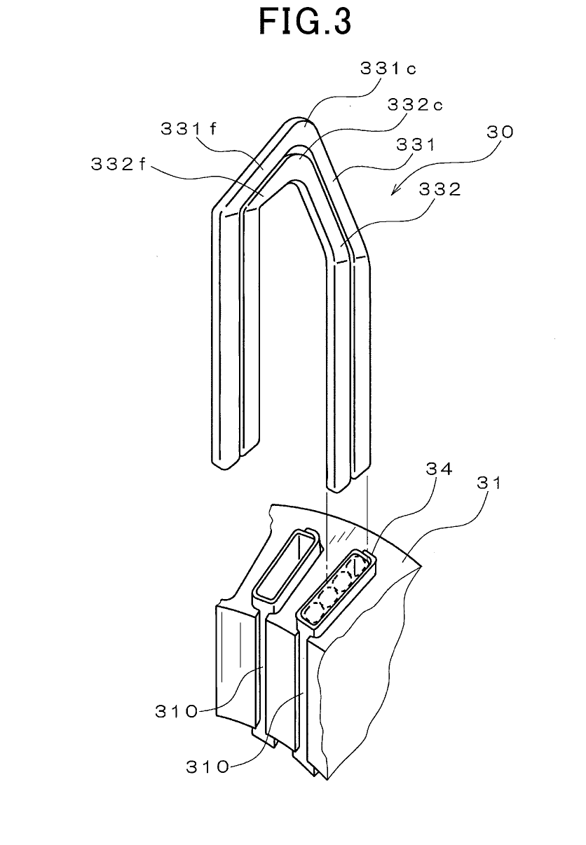

The stator coil 32 can be considered as being formed by connecting electric conductors received in the slots 310 of the stator core 31. That is, as illustrated in FIGS. 2-3, in each of the slots 310 of the stator core 31, there are received an even number (e.g., four in the present embodiment) of electric conductors in alignment with each other in the radial direction of the stator core 31 (or in the depth direction of the slot 310). Hereinafter, for the sake of convenience of explanation, the four electric conductors are sequentially referred to as an innermost conductor, an inner-middle conductor, an outer-middle conductor and an outermost conductor from the radially inside to the radially outside of the slot 310. In addition, in the present embodiment, each of the electric conductors has a substantially rectangular cross section.

Moreover, the electric conductors received in the slots 310 of the stator core 31 are electrically connected to one another in a predetermined pattern.

Specifically, referring to FIG. 2, for one of the slots 310, the innermost conductor 331a in the slot 310 is electrically connected, via a connecting conductor 331c, to the outermost conductor 331b in another one of the slots 310 which is positioned away from the slot 310 by one magnetic pole pitch in the clockwise direction; the connecting conductor 331c is located on a first axial side of the stator core 31 (i.e., the lower side in FIG. 2 and the rear side in FIG. 1). In addition, it should be noted that “the clockwise direction” hereinafter denotes the clockwise direction with the point of sight located on the first axial side of the stator core 31.

Similarly, for one of the slots 310, the inner-middle conductor 332a in the slot 310 is connected, via a connecting conductor 332c, to the outer-middle conductor 332b in another one of the slots 310 which is positioned away from the slot 310 by one magnetic pole pitch in the clockwise direction; the connecting conductor 332c is also located on the first axial side of the stator core 31.

Consequently, on the first axial side of the stator core 31, each of the connecting conductors 332c that respectively connect pairs of the inner-middle conductors 332a and the outer-middle conductors 332b is partially surrounded by a corresponding one of the connecting conductors 331c that respectively connect pairs of the innermost conductors 331a and the outermost conductors 331b. As a result, all the connecting conductors 332c together form an axially inner layer of the rear-side coil end part 32R of the stator coil 32; all the connecting conductors 331c together form an axially outer layer of the rear-side coil end part 32R of the stator coil 32.

Moreover, for one of the slots 310, the inner-middle conductor 332a in the slot 310 is electrically connected, on a second axial side of the stator core 31 (i.e., the upper side in FIG. 2 and the front side in FIG. 1), to the innermost conductor 331a′ in another one of the slots 310 which is positioned away from the slot 310 by one magnetic pole pitch in the clockwise direction. More specifically, the inner-middle conductor 332a is electrically connected to the innermost conductor 331a′ by joining, for example by TIG welding or ultrasonic welding, a pair of connecting conductors 332g and 331g′ that respectively extend from the inner-middle conductor 332a and the innermost conductor 331a′. In addition, it should be noted that the superscript ['] (i.e., apostrophe) is attached to some of the electric conductors hereinafter only for the sake of convenience of explanation and ease of understanding.

Similarly, for one of the slots 310, the outermost conductor 331b′ in the slot 310 is electrically connected, on the second axial side of the stator core 31, to the outer-middle conductor 332b in another one of the slots 310 which is positioned away from the slot 310 by one magnetic pole pitch in the clockwise direction. More specifically, the outermost conductor 331b′ is electrically connected to the outer-middle conductor 332b by joining, for example by TIG welding or ultrasonic welding, a pair of connecting conductors 331g′ and 332g that respectively extend from the outermost conductor 331b′ and the outer-middle conductor 332b.

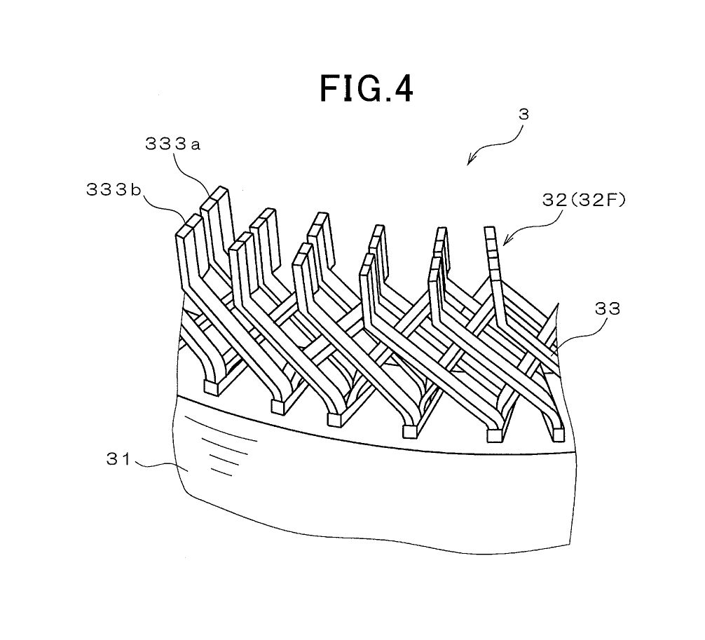

Consequently, on the second axial side of the stator core 31, each of joints 333a formed between end portions 332d of the connecting conductors 332g and end portions 331d′ of the connecting conductors 331g′ is offset from a corresponding one of joints 333b formed between end portions 331e′ of the connecting conductor 331g′ and end portions 332e of the connecting conductors 332g both in the radial and circumferential directions of the stator core 31. As a result, as shown in FIG. 4, all the joints 333a fall on the same circle to form a radially inner layer of the front-side coil end part 32F of the stator coil 32; all the joints 333b fall on the same circle to form a radially outer layer of the front-side coil end part 32F.

Moreover, in the present embodiment, the stator coil 32 is formed of a plurality of substantially U-shaped electric conductor segments 30. Further, the electric conductor segments 30 are comprised of a plurality of pairs of large and small electric conductor segments 331 and 332. More specifically, as shown in FIG. 2, each connected set of the innermost conductor 331a, outermost conductor 331b, connecting conductor 331c on the first axial side of the stator core 31 and connecting conductors 331g on the second axial side of the stator core 31 is formed in one piece construction by using one of the large electric conductor segments 331. On the other hand, each connected set of the inner-middle conductor 332a, outer-middle conductor 332b, connecting conductor 332c on the first axial side of the stator core 31 and connecting conductors 332g on the second axial side of the stator core 31 is formed in one piece construction by using one of the small electric conductor segments 332.

In other words, each of the large electric conductor segments 331 has a pair of in-slot portions 331a and 331b respectively received in two slots 310 of the stator core 31 which are circumferentially apart from each other by one magnetic pole pitch, a turn portion 331c that connects the pair of in-slot portions 331a and 331b on the first axial side of the stator core 31, and a pair of oblique portions 331g that respectively protrude from the pair of in-slot portions 331a and 331b on the second axial side of the stator core 31 and extend obliquely at predetermined angles with respect to the axial direction of the stator core 31. In addition, the turn portion 331c includes a pair of oblique portions 331f that extend obliquely at predetermined angles with respect to the axial direction of the stator core 31. Similarly, each of the small electric conductor segments 332 has a pair of in-slot portions 332a and 332b respectively received in two slots 310 of the stator core 31 which are circumferentially apart from each other by one magnetic pole pitch, a turn portion 332c that connects the pair of in-slot portions 332a and 332b on the first axial side of the stator core 31, and a pair of oblique portions 332g that respectively protrude from the pair of in-slot portions 332a and 332b on the second axial side of the stator core 31 and extend obliquely at predetermined angles with respect to the axial direction of the stator core 31. In addition, the turn portion 332c includes a pair of oblique portions 332f that extend obliquely at predetermined angles with respect to the axial direction of the stator core 31.

Consequently, with the large and small electric conductor segments 331 and 332, the stator coil 32 is formed in a lap winding manner on the stator core 31. Moreover, all of the turn portions 331c of the large electric conductor segments 331 and the turn portions 332c of the small electric conductor segments 332 together constitute the rear-side coil end part 32R of the stator coil 32; all of the oblique portions 331g of the large electric conductor segments 331 and the oblique portions 332g of the small electric conductor segments 332 together constitute the front-side coil end part 32F of the stator coil 32 (see FIG. 1). In addition, during rotation of the rotor 2, the flow of cooling air created by the cooling fans 22 and 23 passes through the front-side and rear-side coil end parts 32F and 32R of the stator coil 32, thereby cooling them.

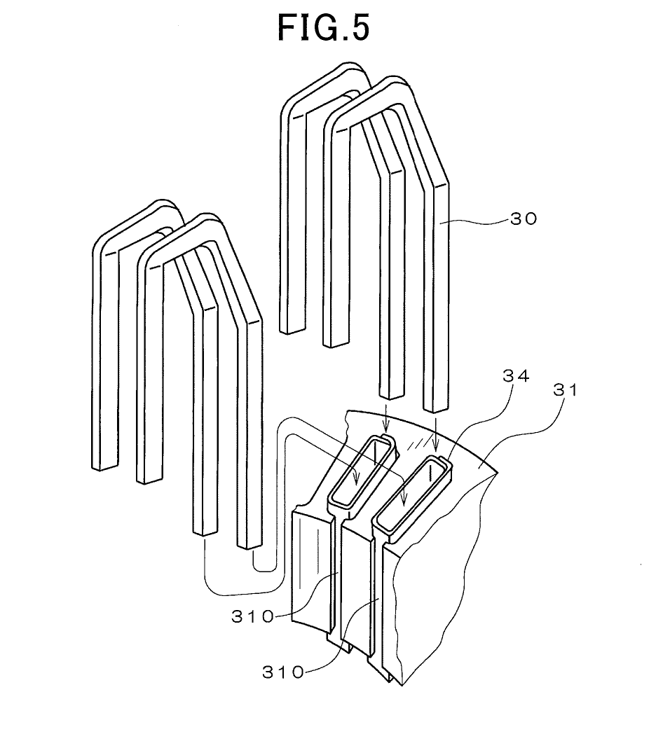

In addition, as shown in FIG. 5, the stator coil 32 may also be formed of a plurality of identical electric conductor segments 30 which are substantially U-shaped. Further, with the identical electric conductor segments 30, the stator coil 32 may be formed in a wave winding manner on the stator core 31.

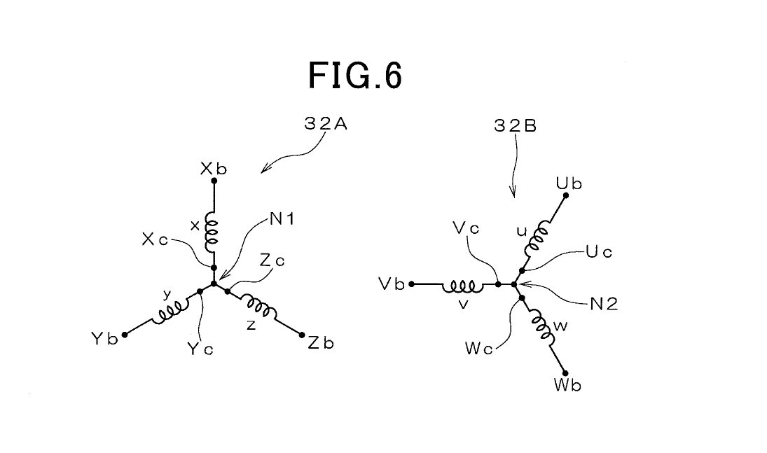

In the present embodiment, the electric conductor segments 30 are electrically connected in the above-described manner to form a pair of first and second three-phase coils 32A and 32B as shown in FIG. 6. Moreover, the first and second three-phase coils 32A and 32B together constitute the stator coil 32.

In other words, in the present embodiment, the stator coil 32 is comprised of the pair of three-phase coils 32A and 32B. In addition, the first and second three-phase coils 32A and 32B are mounted on the stator core 31 so as to be different in phase from each other by 30° in electrical angle.

As shown in FIG. 6, the first three-phase coil 32A includes three phase windings x, y and z, which are Y-connected with each other. The phase winding x has its opposite end portions respectively led out as lead wires Xb and Xc from the rear-side coil end part 32R of the stator coil 32. The phase winding y has its opposite end portions respectively led out as lead wires Yb and Yc from the rear-side coil end part 32R. The phase winding z has its opposite end portions respectively led out as lead wires Zb and Zc from the rear-side coil end part 32R. The lead wires Xb, Yb and Zb are electrically connected to the rectifier 5 of the alternator 1. On the other hand, the lead wires Xc, Yc and Zc are joined together to define a neutral point N1 of the first three-phase coil 32A.

Similarly, the second three-phase coil 32B includes three phase windings u, v and w, which are Y-connected with each other. The phase winding u has its opposite end portions respectively led out as lead wires Ub and Uc from the rear-side coil end part 32R of the stator coil 32. The phase winding v has its opposite end portions respectively led out as lead wires Vb and Vc from the rear-side coil end part 32R. The phase winding w has its opposite end portions respectively led out as lead wires Wb and We from the rear-side coil end part 32R. The lead wires Ub, Vb and Wb are electrically connected to the rectifier 5 of the alternator 1. On the other hand, the lead wires Uc, Vc and We are joined together to define a neutral point N2 of the second three-phase coil 32B.

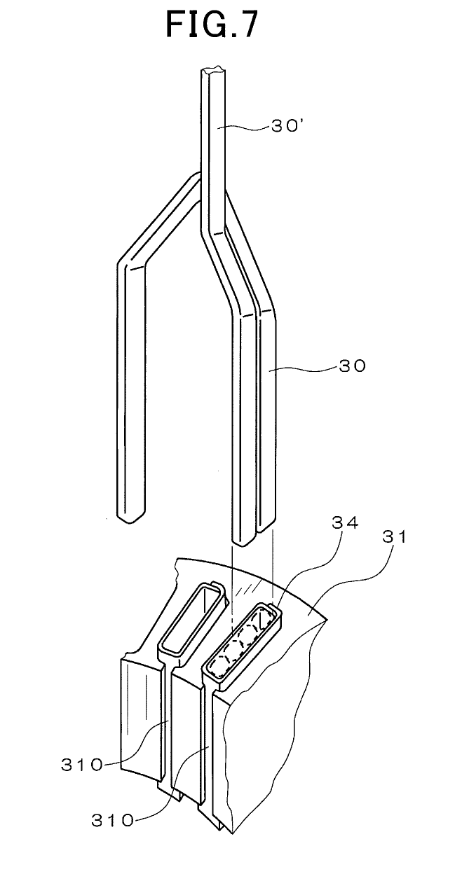

Moreover, in the present embodiment, the lead wires Xb, Yb, Zb, Ub, Vb and Wb, which are led out from the rear-side coil end part 32R of the stator coil 32 and electrically connected to the rectifier 5, are formed using electric conductor segments 30′ as shown in FIG. 7.

Specifically, compared to the above-described substantially U-shaped electric conductor segments 30, each of the electric conductor segments 30′ is not bent back at the turn portion, thus having two straight portions extending parallel to each other. Each of the electric conductor segments 30′ is inserted in a corresponding one of the slots 310 of the stator core 31 from the first axial side of the stator core 31 (i.e., the upper side in FIG. 7 and the rear side in FIG. 1), so as to have one end portion thereof protruding from the corresponding slot 310 on the second axial side (i.e., the lower side in FIG. 7 and the front side in FIG. 1). The end portion is then bent to extend obliquely at a predetermined angle with respect to the axial direction of the stator core 31. Thereafter, the end portion is joined to a corresponding one of the oblique portions of the electric conductor segments 30 (i.e., the oblique portions 331g of the large electric conductor segments 331 and the oblique portions 332g of the small electric conductor segments 332 in FIG. 2), thereby making up a portion of the front-side coil end part 32F of the stator coil 32 as shown in FIG. 4. On the other hand, the other end portions of the electric conductor segments 30′, which remain on the first axial side of the stator core 31, make up the lead wires Xb, Yb, Zb, Ub, Vb and Wb; those lead wires Xb-Zb and Ub-Wb protrude from the rear-side coil end part 32R of the stator coil 32.

Accordingly, with the electric conductor segments 30′, it is possible to easily form the lead wires Xb-Zb and Ub-Wb. In addition, like the electric conductor segments 30, each of the electric conductor segments 30′ also has a substantially rectangular cross section.

Next, a connection portion M of the first three-phase coil 32A which represents the neutral point N1 will be described in detail.

In addition, in the present embodiment, the second three-phase coil 32B has the same configuration and features as the first three-phase coil 32A. Therefore, for the sake of avoiding redundancy, description of a connection portion M of the second three-phase coil 32B which represents the neutral point N2 will be omitted hereinafter.

As described previously, in the present embodiment, the first three-phase coil 32A includes the phase windings x, y and z that are Y-connected to define the neutral point N1 therebetween (see FIG. 6). Further, the lead wires Xc, Yc and Zc, which are respectively drawn from the phase windings x, y and z, are connected together to form the connection portion M which represents the neutral point N1.

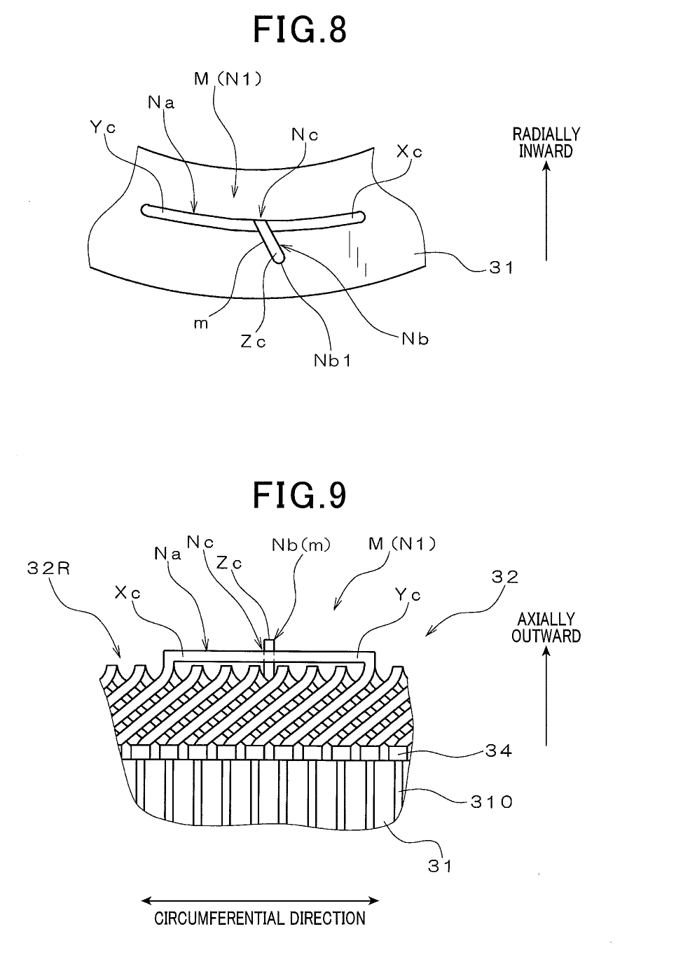

Specifically, in the present embodiment, as shown in FIGS. 8-10, the lead wires Xc and Yc are together implemented by a first connection wire Na which is a single continuous electric conductor wire. The first connection wire Na is arranged so as to extend in the circumferential direction of the stator core 31. The lead wire Zc is implemented by a second connection wire Nb which is also a single continuous electric conductor wire. The second connection wire Nb is bent to include a bend Nb 1 formed radially outside the first connection wire Na and an intersecting part m that extends from the bend Nb1 to the first connection wire Na so as to intersect the first connection wire Na. Further, the intersecting part m is joined, for example by welding, to the first connection wire Na to form a joint (or junction) Nc therebetween.

That is, in the present embodiment, the connection portion M of the first three-phase coil 32A, which represents the neutral point N1, is formed of the first and second connection wires Na and Nb. The first connection wire Na connects the phase windings x and y. The second connection wire Nb connects the phase winding z to the first connection wire Na. The first connection wire Na extends in the circumferential direction of the stator core 31. The second connection wire Nb includes the intersecting part m that extends so as to intersect the first connection wire Na and is jointed to the first connection wire Na to form the joint Nc therebetween. Consequently, when radial vibration is transmitted to the connection portion M of the first stator coil 32A, the second connection wire Nb will function as a strut to support the first connection wire Na, thereby suppressing radial vibration of the connection portion M.

Moreover, in the present embodiment, as shown in FIG. 8, the intersecting part m of the second connection wire Nb extends to the first connection wire Na from the bend Nb 1 that is formed radially outside the first connection wire Na. Consequently, when radial vibration is transmitted to the connection portion M of the first stator coil 32A, the second connection wire Nb will support the first connection wire Na from the radially outside, thereby suppressing the amplitude of radial vibration of the connection portion M in the radially outward direction. As a result, it is possible to secure a sufficient gap between the joint Nc and the internal wall of the frame 4 in which the stator 3 is received, thereby improving the environmental resistance of the alternator 1.

Furthermore, in the present embodiment, as shown in FIG. 9, the first connection wire Na is axially positioned between the stator core 31 and the intersecting part m of the second connection wire Nb. Consequently, it is possible to reduce the axial height of the entire first connection wire Na that extends in the circumferential direction of the stator core 31, thereby improving the vibration resistance of the entire connection portion M of the first three-phase coil 32A.

In addition, in the present embodiment, each of the first and second connection wires Na and Nb has a substantially rectangular cross-sectional shape. Consequently, it is possible to improve the vibration resistance of each of the first and second connection wires Na and Nb, thereby more reliably suppressing radial vibration of the connection portion M.

The above-described stator 3 according to the present embodiment has the following advantages.

In the present embodiment, the stator 3 includes the annular stator core 31 and the stator coil 32. The stator core 31 has the slots 310 formed therein. The slots 310 are spaced from one another in the circumferential direction of the stator core 31. The stator coil 32 includes the phase windings x, y and z and the connection portion M located outside the slots 310 of the stator core 31. The connection portion M is formed of the first connection wire Na that connects the phase windings x and y and the second connection wire Nb that connects the phase winding z to the first connection wire Na. The first connection wire Na is arranged so as to extend in the circumferential direction of the stator core 31. The second connection wire Nb is bent to include the bend Nb1 and the intersecting part m that extends from the bend Nb1 to the first connection wire Na so as to intersect the first connection wire Na. The intersecting part m of the second connection wire Nb is joined to the first connection wire Na to form the joint Nc therebetween.

With the above configuration, when radial vibration is transmitted to the connection portion M, the second connection wire Nb will function as a strut to support the first connection wire Na, thereby suppressing radial vibration of the connection portion M.

Moreover, in the present embodiment, the bend Nb1 of the second connection wire Nb is formed radially outside the first connection wire Na, and the intersecting part m of the second connection wire Nb extends from the bend Nb1 to the first connection wire Na.

With above configuration, when radial vibration is transmitted to the connection portion M, the second connection wire Nb will support the first connection wire Na from the radially outside, thereby suppressing the amplitude of radial vibration of the connection portion M in the radially outward direction. As a result, it is possible to secure a sufficient gap between the connection portion M and the internal wall of the frame 4 in which the stator 3 is received, thereby improving the environmental resistance of the alternator 1.

Furthermore, in the present embodiment, the first connection wire Na is axially positioned between the stator core 31 and the intersecting part m of the second connection wire Nb.

With the above configuration, it is possible to reduce the axial height of the entire first connection wire Na that extends in the circumferential direction of the stator core 31, thereby improving the vibration resistance of the entire connection portion M.

In the present embodiment, each of the first and second connection wires Na and Nb is configured to have a substantially rectangular cross section.

With the above configuration, it is possible to improve the vibration resistance of each of the first and second connection wires Na and Nb, thereby more reliably suppressing radial vibration of the connection portion M.

While the above particular embodiment has been shown and described, it will be understood by those skilled in the art that various modifications, changes, and improvements may be made without departing from the spirit of the invention.

(1) For example, in the previous embodiment, the intersecting part m of the second connection wire Nb is arranged to extend obliquely with respect to the first connection wire Na (see FIG. 8).

However, as shown in FIG. 11, the intersecting part m of the second connection wire Nb may be arranged to extend in a radial direction of the stator core 31, thereby intersecting the first connection wire Na at right angles. With this arrangement, when radial vibration is transmitted to the connection portion M, the second connection wire Nb will support the first connection wire Na in the radial direction, thereby more effectively suppressing radial vibration of the connection portion M.

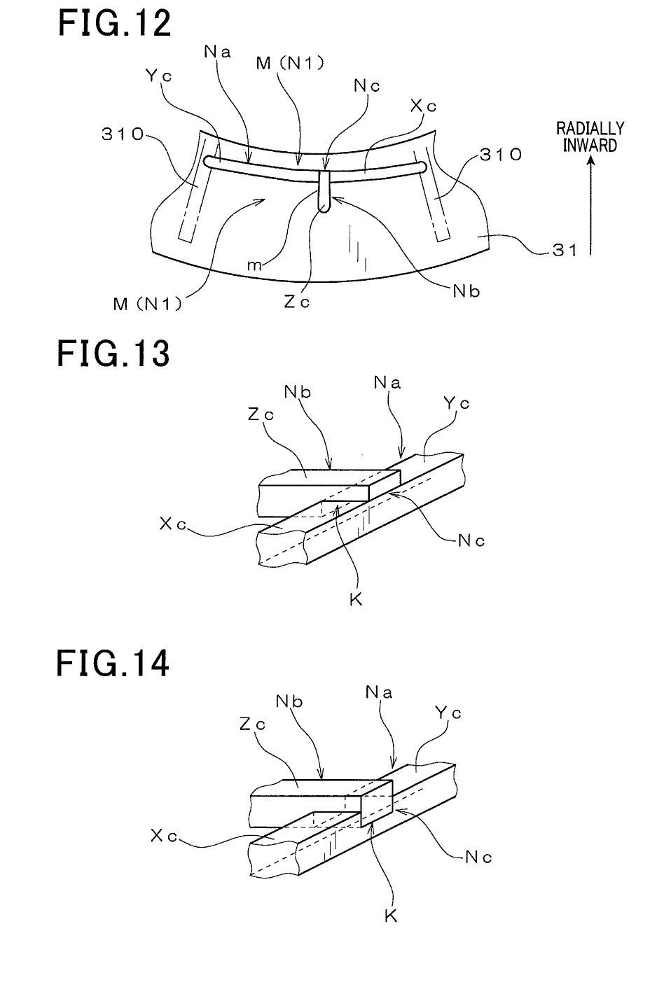

(2) It is preferable that each of opposite end portions of the first connection wire Na (i.e., the lead wire Xc+the lead wire Ye) is led out (or protrudes) from a radially inner part of a corresponding one of the slots 310 of the stator core 31, as shown in FIG. 12. In this case, it is possible to locate the joint Nc formed between the first connection wire Na and the intersecting part m of the second connection wire Nb in close vicinity to the radially inner periphery of the stator core 31. Consequently, it is possible to more reliably secure a sufficient gap between the joint Nc and the internal wall of the frame 4 in which the stator 3 is received, thereby further improving the environmental resistance of the alternator 1.

(3) It is preferable to form, at the joint Nc, a cut in either or both of the first and second connection wires Na and Nb, thereby positioning them with respect to each other. With the cut, it is possible to reduce the axial height of the joint Nc, thereby widening the gap between the joint Nc and the internal wall of the frame 4 and thus improving the environmental resistance of the alternator 1. Moreover, with the cut, it is also possible to stably hold the first and second connection wires Na and Nb relative to each other in joining them to form the joint Nc therebetween. Accordingly, in joining the first and second connection wires Na and Nb by, for example, welding, it is unnecessary to strip the first and second connection wires Na and Nb of their respective insulating coats over a wide range. Consequently, after joining the first and second connection wires Na and Nb, it is unnecessary to apply a large amount of insulating resin to cover the joint Nc and the stripped portions of the first and second connection wires Na and Nb. As a result, it is possible to reduce the manufacturing cost of the stator 3. In addition, it is also unnecessary to bind the first and second connection wires Na and Nb to the rear-side coil end part 32R of the stator coil 32 with threads. In other words, it unnecessary to employ any additional member for holding the first and second connection wires Na and Nb. As a result, it is possible to further reduce the manufacturing cost of the stator 3.

Specifically, as shown in FIG. 13, a cut K may be formed in the shape of a recess only in the second connection wire Nb so that the first connection wire Na can be fitted in the cut K. In addition, it is easy to form such a cut K in a distal end portion of the second connection wire Nb.

Alternatively, as shown in FIG. 14, a cut K may be formed in the shape of a recess only in the first connection wire Na so that the second connection wire Nb can be fitted in the cut K.

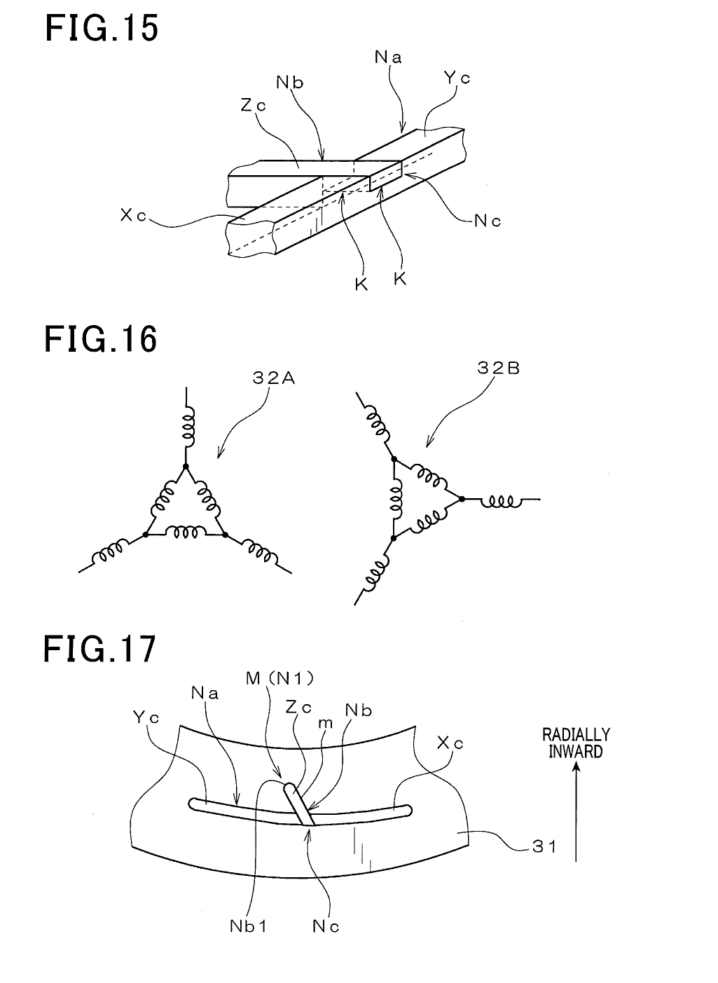

Otherwise, as shown in FIG. 15, each of the first and second connection wires Na and Nb may have a cut K formed therein in the shape of a recess so that: the first connection wire Na can be fitted in the cut K formed in the second connection wire Nb; and the second connection wire Nb can be fitted in the cut K formed in the first connection wire Na. In this case, it is possible to more stably hold the first and second connection wires Na and Nb in joining them to form the joint Nc therebetween.

(4) In the previous embodiment, each of the phase windings x-z and u-w of the stator coil 32 is formed of the electric conductor segments 30 and 30′ which have the substantially rectangular cross-sectional shape. However, each of the phase windings x-z and u-w of the stator coil 32 may also be formed of electric conductor segments which have other cross-sectional shapes (e.g., a substantially circular cross-sectional shape).

Furthermore, each of the phase windings x-z and u-w of the stator coil 32 may be formed of, instead of the electric conductor segments, a single continuous electric conductor wire which has a suitable cross-sectional shape (e.g., a substantially rectangular or circular cross-sectional shape).

(5) In the previous embodiment, the stator coil 32 is comprised of the first and second three-phase coils 32A and 32B each of which is Y-connected (see FIG. 6).

However, as shown in FIG. 16, the stator coil 32 may also be comprised of a pair of three-phase windings 32A and 32B each of which is connected in a Δ-Y combined manner (or is A-Y-connected). In this case, in the stator coil 32, there are a total of six connection portions M, at each of which three phase windings can be connected in the manner described in the previous embodiment.

Moreover, the stator coil 32 may also be comprised of a pair of three-phase windings one of which is Y-connected while the other is Δ-Y-connected.

Furthermore, the stator coil 32 may include only one three-phase coil which is either Y-connected or Δ-Y-connected.

(6) In the previous embodiment, the first connection wire Na is axially positioned between the stator core 31 and the intersecting part m of the second connection wire Nb (see FIG. 8).

However, it is also possible to axially position the intersecting part m of the second connection wire Nb between the stator core 31 and the first connection wire Na.

(7) In the previous embodiment, the bend Nb1 of the second connection wire Nb is formed radially outside the first connection wire Na and the intersecting part m of the second connection wire Nb extends from the bend Nb1 to the first connection wire Na (see FIG. 8).

However, as shown in FIG. 17, the bend Nb 1 of the second connection wire Nb may be formed radially inside the first connection wire Na. In this case, the intersecting part m of the second connection wire Nb extends from the radially inside to the radially outside of the first connection wire Na.

(8) In the previous embodiment, the lead wires Xc and Yc are together implemented by the first connection wire Na while the lead wire Zc is alone implemented by the second connection wire Nb.

However, it is also possible to implement the lead wires Yc and Zc (or alternatively the lead wires Xc and Zc) together by the first connection wire Na while implementing the lead wire Xc (or alternatively the lead wire Yc) alone by the second connection wire Nb.

(9) In the previous embodiment, the present invention is applied to the stator 3 of the automotive alternator 1.

However, the invention can also be applied to stators of other rotating electric machines, such as a stator of an electric motor and a stator of a motor-generator that can selectively function either as an electric motor or as an electric generator.

What is claimed is:

1. A stator for a rotating electric machine, the stator comprising:
an annular stator core having a plurality of slots formed therein, the slots being spaced from one another in a circumferential direction of the stator core; and
a stator coil including first to third phase windings mounted on the stator core and a connection portion located outside the slots of the stator core, the connection portion being formed of a first connection wire connecting the first and second phase windings and a second connection wire connecting the third phase winding to the first connection wire,
wherein
the first connection wire is arranged so as to extend in the circumferential direction of the stator core,
the second connection wire is bent to include a bend and an intersecting part that extends from the bend to the first connection wire so as to intersect the first connection wire, and
the intersecting part of the second connection wire is joined to the first connection wire with a joint formed therebetween.

2. The stator as set forth in claim 1, wherein the intersecting part of the second connection wire extends in a radial direction of the stator core so as to intersect the first connection wire at right angles.

3. The stator as set forth claim 1, wherein the bend of the second connection wire is formed radially outside the first connection wire, and the intersecting part of the second connection wire extends from the bend to the first connection wire.

4. The stator as set forth in claim 1, wherein each of opposite end portions of the first connection wire is led out from a radially inner part of a corresponding one of the slots of the stator core.

5. The stator as set forth in claim 1, wherein the first connection wire is axially positioned between the stator core and the intersecting part of the second connection wire.

6. The stator as set forth in claim 1, wherein at the joint, a cut is formed in either or both of the first and second connection wires for positioning them with respect to each other.

7. The stator as set forth in claim 6, wherein at the joint, a cut is formed in the shape of a recess only in the second connection wire so that the first connection wire is fitted in the cut.

8. The stator as set forth in claim 6, wherein at the joint, each of the first and second connection wires has a cut formed therein in the shape of a recess so that: the first connection wire is fitted in the cut formed in the second connection wire; and the second connection wire is fitted in the cut formed in the first connection wire.

9. The stator as set forth in claim 1, wherein each of the first and second connection wires has a substantially rectangular cross section.
